(19) United States
(12) Patent Application Publication
(10) Pub. No.: US 2006/0289129 A1
(43) Pub. Date: Dec. 28, 2006

(54) Adjustable motor housing for a barrier locking operator

(76) Inventors: Willis J. Mullet, Gulf Breeze, FL (US); Derek S. Paquette, Daphne, AL (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/165,074

(22) Filed: Jun. 22, 2005

(51) Int. Cl. E05D 15/00

(52) U.S. Cl. 160/201

(57) ABSTRACT

A door system having a sectional door (D) moveable between an open position and a closed position, a track system (T, T1) guiding movement of the sectional door, and an operator system (10) driving movement of the sectional door, said operator system including a motor assembly (42) having an adjustable housing (48) and capable of pivotal movement to a door locking position, said adjustable housing having a base section (70), an extendable section (72), and a latching mechanism (100) for maintaining the extendable section in a desired position and for permitting selective axially repositioning of the extendable section relative to the base section.

### TECHNICAL FIELD

The present invention generally relates to an operator system for a moveable barrier. More particularly, the present invention relates to an operator system for driving opening and closing movements of a sectional door. More specifically, the present invention relates to an operator system having a motor housing capable of pivotal movements to selectively engage the sectional door. Still more specifically, the present invention relates to an operator system employing an adjustable motor housing to lock the sectional door in the closed position.

### BACKGROUND ART

Typically, moveable barriers such as sectional doors are guided by track systems between opened and closed positions, and motorized operators are provided to drive movement of the sectional doors along the track systems. To provide a forcible stop against opening of the sectional doors in jack-shaft operators, a portion of such motorized operators can be made pivotal. Advantageously, the motor assemblies can be made to pivot between engaged and disengaged positions. In the engaged position, the motor assemblies can contact or block portions of the sectional doors, and prevent upward movement thereof. In doing so, the motor assemblies can be positioned to lock the sectional doors in the closed position. As such, the motor assemblies can prevent the sectional doors from being forced open by a person attempting to gain unauthorized access.

Counterbalance systems are widely used in conjunction with the motorized operators to facilitate movement of the sectional doors. The mounting heights of the counterbalance systems relative to the sectional doors can vary depending on the radius of the transitional track sections used between the vertical and horizontal track sections of the track systems. The radius of the transitional sections can determine how smoothly the sectional door opens and closes. For example, the larger the radius of the transitional track sections, the smoother the opening and closing movements of the sectional door tend to become. However, the larger the radius of transitional track sections become, the more space that is required above the sectional door. As such, compromises are made when installing sectional doors to account for the available clearance in a particular installation in terms of the ceiling downwardly projecting support beams and other obstructions. Generally, transitional track sections with a radius affording the smoothest operation of the sectional door within the clearance above the sectional door are employed.

As the radius of the transitional track sections varies according to the installation, so does the distance between the sectional door and counterbalance systems. The use of a motor housing positioned in close proximity to block the door with the largest radius transitional track sections and overlapingly engage the door with lesser radii produced some disadvantages. In particular, this approach resulted in undesirable noise when the operator struck the door and in some instances damage to the door and or operator assembly. However, to provide for positioning of the operator blocking assemblies in close proximity to the upper portion of the sectional doors, the motorized operators must be made with operator motor housings of differing dimensions depending upon the radius of the transitional track sections in a particular installation.

Because such operators are assembled at worksites in remote locations, providing various housings of different fixed lengths for every installation is impracticable. Besides the cost of manufacturing various housings of different fixed lengths, these various housings must be made available at the worksites. Therefore, as an alternative to fixed length housings, the housings have been modified by using extension pieces attached to the housings using additional fasteners.

For example, fasteners, such as set screws, have been used to maintain the position of the extension pieces relative to the housings. However, adjustment of the extension pieces relative to the housings has proven difficult using the set screws. Further, the set screws must be inserted at multiple positions on the extensions pieces which can be difficult after the motorized operator has been positioned on the counterbalance system above the sectional door.

To simplify adjustment of the extension pieces relative to the operator motor housings, the extension pieces and housings have been made to include mating threads. By twisting the extension pieces relative to the housings, the effective length of the housings can be adjusted using the mating threads to enable positioning relative to portions of the sectional doors. However, due to vibration caused by operation of the motorized operators and movement of the sectional doors, such adjustment is oftentimes subject to unwanted alteration. Therefore, when using the mating threads, additional fasteners are again required. Fasteners, such as a bolt and a locking nut, are needed to prevent unwanted changes in the effective length of the housings. Besides adding complexity to the installation of motorized operators, additional fasteners add additional expense and complexity to the motorized operators.

Consequently, there is a need for an operator system employing an adjustable motor housing to lock the sectional door in the closed position that is easily adjusted and remains in position over many opening and closing cycles of the sectional door and attendant movement and vibration without the need for additional relatively complex components or fasteners.

### DISCLOSURE OF THE INVENTION

Therefore, an object of the present invention is to provide an operator system employing an adjustable motor housing to lock a sectional door in the closed position. Another object of the present invention is to provide an operator system employing an adjustable motor housing that is easily adjusted and remains in position over many opening and closing cycles of the sectional door. A further object of the present invention is to provide an operator system employing an adjustable motor housing that does not need additional components and/or fasteners to maintain the position thereof.

Another object of the invention is to provide an adjustable motor housing requiring only a two-piece motor housing and no other accessory components. A still further object is to provide such a motor housing that is easier and quicker to adjust by simple pull down of one piece of the two piece motor housing. Yet another object of the invention is to provide such a motor housing that is relative easy and therefore inexpensive to manufacture.

In general, the present invention contemplates a door system comprising, a sectional door moveable between an open position and a closed position, a track system guiding movement of the sectional door, and an operator system driving movement of the sectional door, said operator system including a motor assembly having an adjustable housing and capable of pivotal movement to a door locking position, said adjustable housing having a base section, an extendable section, and a latching mechanism for maintaining the extendable section in a desired position and for permitting selective axially repositioning of the extendable section relative to the base section.

### BRIEF DESCRIPTION OF THE DRAWINGS

FIG. 1 is a rear perspective view of a door system including an operator system for raising and lowering a sectional door, depicting a pivotal, adjustable motor housing positioned to selectively lock the sectional door in the closed position.

FIG. 2 is a rear elevational view of the door system of FIG. 1.

FIG. 3 is a side elevational view of the door system of FIG. 1.

FIG. 4 is an enlarged side elevational view of FIG. 1 with portions broken away depicting the operator system with the adjustable motor housing in the locked position in proximity to the sectional door and in the operating position in chain lines.

FIG. 5 is an enlarged rear perspective view of the adjustable motor housing depicted in FIGS. 1-4, with the adjustable motor housing in an extended position.

FIG. 6 is an enlarged rotated cross-sectional perspective view of the adjustable motor housing taken substantially along line 6-6 of FIG. 5.

FIG. 7 is an enlarged front cross-sectional perspective view similar to FIG. 6 of the adjustable motor housing in a retracted position.

FIG. 8 is an enlarged cross-sectional perspective view similar to FIG. 6 of the adjustable motor housing in an extended position and rotated to show additional details of the locking device for the two-piece housing.

FIG. 9 is an enlarged rear cross-sectional perspective view similar to FIG. 7 of the adjustable motor housing in a retracted position and rotated to show additional details of the locking device for the two-piece housing.

### BEST MODE FOR CARRYING OUT THE INVENTION

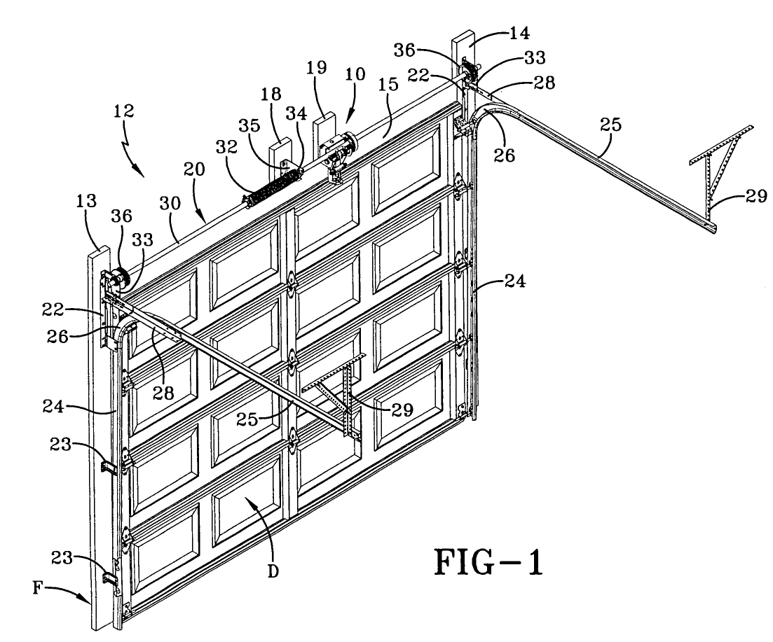

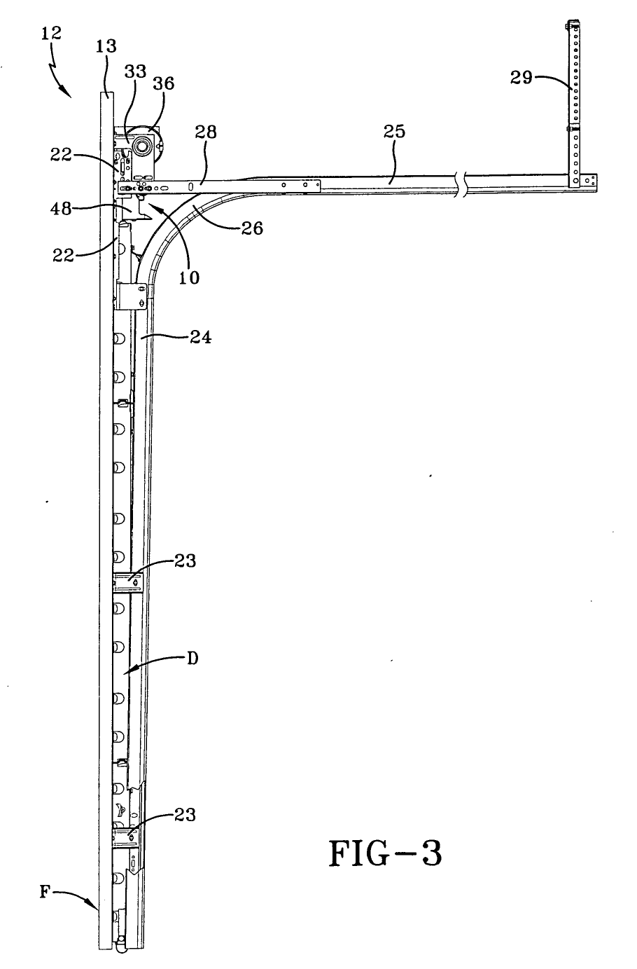

A motorized operator system according to the concepts of the present invention is generally indicated by the numeral 10 in the accompanying drawings. As shown in FIGS. 1-3, the operator system 10 is employed in a sectional door system, generally indicated by the numeral 12. The door system 12 is provided to facilitate opening and closing movement of a sectional door, generally indicated by the letter D, of a type commonly employed in utility buildings and residential garages. For example, the door system 12 supports the sectional door D for movement relative to an opening defined by a frame, generally indicated by the letter F. The operator system 10 drives opening and closing movement of the sectional door D relative to the opening.

As shown in FIGS. 1-3, the frame F includes a pair of spaced jambs 13, 14 that are generally parallel and extend vertically upwardly from the floor (not shown). The jambs 13, 14 are spaced and joined at their vertically upper extremity by a header 15 to thereby delineate a generally inverted U-shape for the frame F around the opening for the sectional door D. Extending upwardly from the header 15 are header extensions 18 and 19. As discussed below, the header extension 18 aids in supporting a counterbalance system, generally indicated by the numeral 20, and the header extension 19 may be provided to support the operator system 10. The frame F, including the header extensions 18 and 19, is normally constructed of lumber, as well known to persons skilled in the art, for purposes of reinforcement, and to facilitate the attachment of the elements supporting and controlling the sectional door D.

Track assemblies, generally indicated by the letters T, T′, may be mounted to the frame F using flag angles 22 and brackets 23 that are fastened to the jambs 13, 14. The track assemblies T, T′ each include vertical track sections 24, horizontal track sections 25, and transitional track sections 26 joining the vertical track sections 24 and horizontal track sections 25. Additional support for the horizontal track sections 25 may be provided by horizontal angles 28 extending rearwardly from the jambs 13, 14, and struts 29 located proximate the distal ends of the horizontal track sections 25, and attached to the overhead structure (not shown). As is well known to persons skilled in the art, the track assemblies T, T′ provide a guide system for rollers attached to the side of the sectional door D, and define the travel of the sectional door D between open and closed positions.

As shown in FIGS. 1-3, the counterbalance system 20 provides a counterbalancing force partially offsetting the weight of the sectional door D. The counterbalance system 20 mechanically interrelates with the sectional door D using a drive tube 30. At one end, a coil spring 32 is interconnected with the drive tube 30, and, at the other end, is fixedly attached relative to the drive tube 30. A counterbalancing force is developed by the coil spring 32 upon rotation of the drive tube 30 and applied to the sectional door D.

The drive tube 30 is rotatably supported by brackets 33 attached to the jambs 13, 14 proximate the flag angles 20. In addition, the drive tube 30 may be further supported at or proximate its center by a support bearing 34 and bracket 35. For example, the bracket 35 is fastened to the header extension 18, and the drive tube 30 is received within the support bearing 34 that is rotatably carried by the bracket 35.

Cable drum mechanisms 36 are mounted on the drive tube 30 proximate the ends thereof. The cable drum mechanisms 36 each have a cable (not shown) reeved thereabout which is affixed to the sectional door D preferably proximate the bottom. The winding and unwinding of the cable on the cable drum mechanisms 36 facilitates opening and closing movements of the sectional door D responsive to rotation of the drive tube 30, and, hence, generates a variable counterbalancing force in the coil spring. The counterbalancing force aids in raising and lowering the sectional door D in conventional fashion.

Depending on the location of the counterbalance system 20, the operator system 10 can be mounted adjacent the header 15 at various vertical positions above the sectional door D. In particular, a motor bracket 37 is mounted to an appropriately positioned header extension 19. The motor bracket 37 carries a motor assembly, generally indicated by the numeral 42, in such a manner as to rotate the drive tube 30 in either direction and thus move the door in the track assemblies. The motor assembly 42 is at least partially received in a motor housing, generally indicated by the numeral 48. The motor assembly 42 may be coupled to the tube 30 in any number of ways such as disclosed in applicant assignees' U.S. Pat. No. 6,851,465, or in a U.S. patent application entitled Pivoting Operator and Related Controls filed on or about the same date as the present application, both of which are incorporated herein by reference.

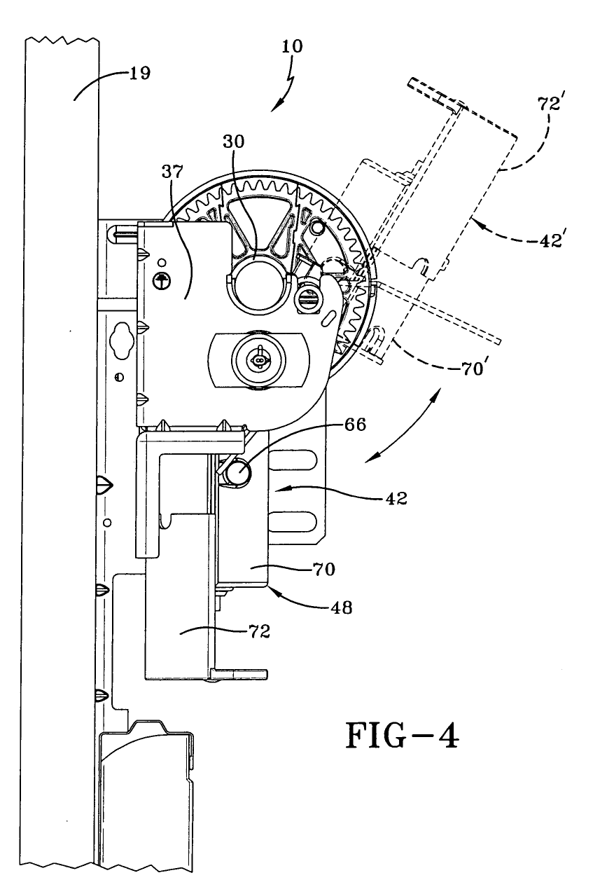

As best seen in FIG. 4, the motor assembly 42 is pivotable between an operating position 42′ shown in chain lines and a blocking position. The pivotable movement may be attained in any manner, such as by selective use of the gears that interconnect the drive tube 30 to the motor assembly, or with spring biasing forces, or in any manner apparent to one skilled in the art. In any event, the motor assembly 42 is maintained in the operating position 42′ while the door is moved between open and closed limit positions. When the door is moved to the closed limit position, this event is recognized by the operator system 10 and the motor assembly 42 is pivoted to the blocking position 42. When in the blocking position, any upward force applied to the door, manual or otherwise, is blocked by the motor housing 48. In other words, when an upward force is applied and door D commences upward movement, a top edge of the top section of door D comes in contact with the motor housing and the door is prevented from moving further upwardly. When the door is commanded by the operator system to move upwardly, the motor assembly 42, along with the motor housing 48, returns to the operating position 42′ and the door is free to move upwardly.

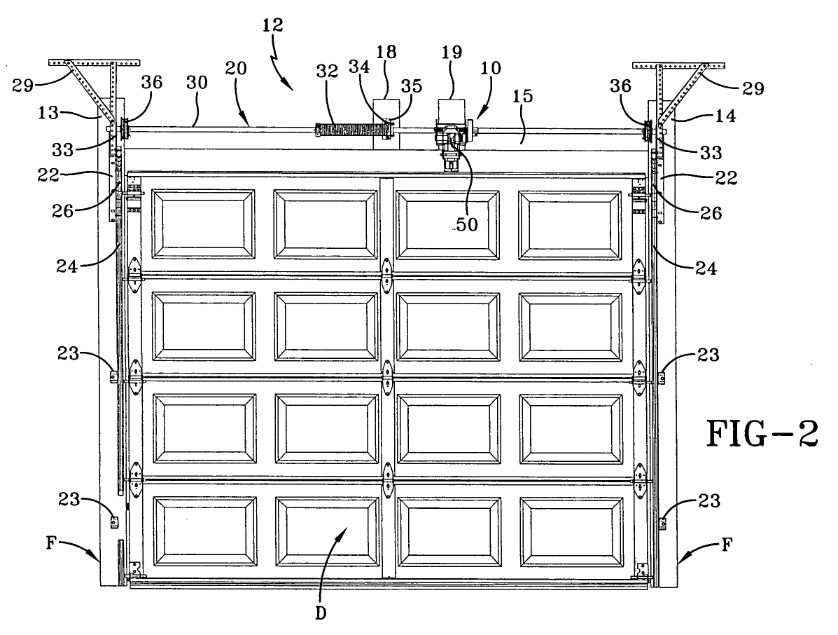

To account for the mounting position of the operator system 10, the motor housing 48 is made adjustable. As such, the motor housing 48 can be extended or retracted to facilitate location at a blocking position proximate a portion of the sectional door D. For example, the motor housing 48 includes a base section, generally indicated by the numeral 70, and an extendable section, generally indicated by the numeral 72. The base section 70 covers the motor of the motor assembly 42, and is fixedly attached to a gear case housing 50 (FIG. 2). As shown, the extendable section 72 telescopically interfits with the base section 70 for selective positioning axially of base section 70.

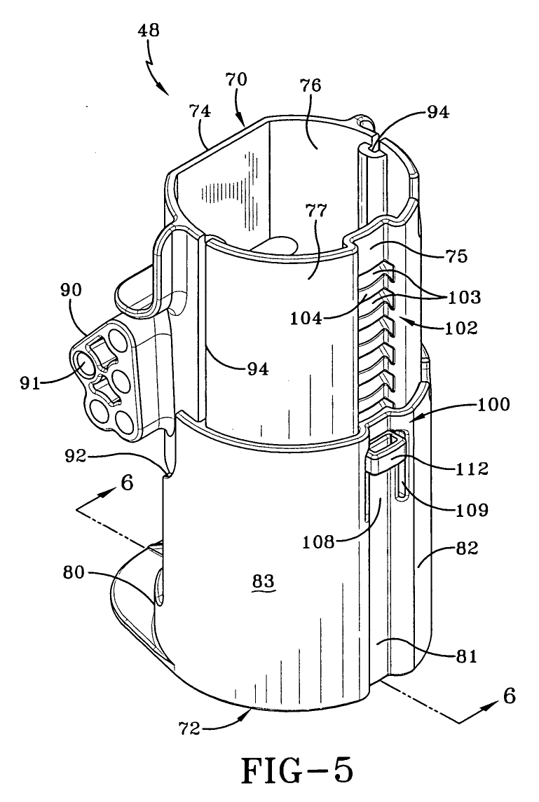

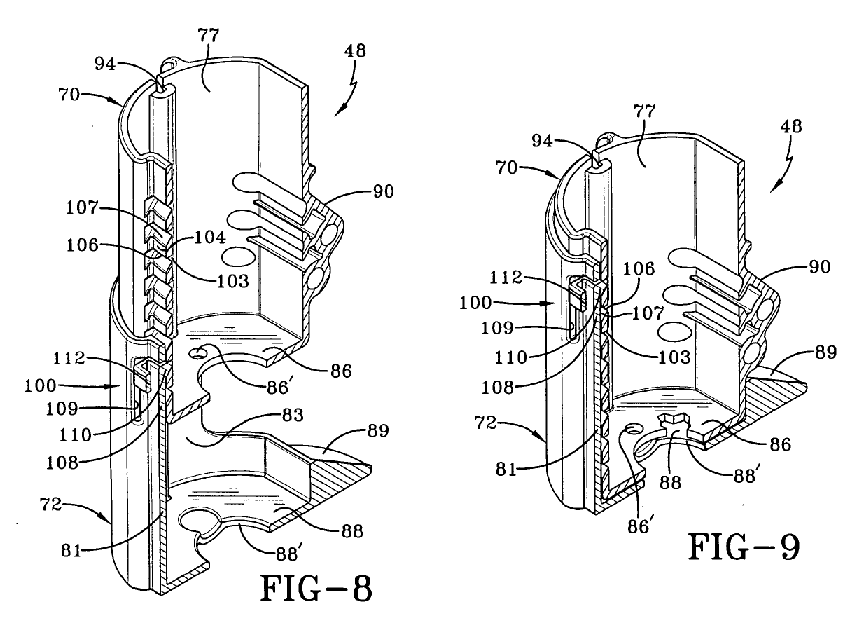

As shown in FIGS. 5-9, the base section 70 is configured to fit within the extendable section 72. The base section 70 is sized slightly smaller than the extendable section 72, and both have generally circular cross-sectional shapes. The base section 70 includes a front wall 74, a rear wall 75, and side walls 76 and 77. The side walls 76 and 77 extend between the front wall 74 and rear wall 75, and are curved to provide the generally circular cross-sectional shape of the base section 70. Like the base section 70, the extendable section 72 includes a front wall 80, a rear wall 81, and side walls 82 and 83. The side walls 82 and 83 extend between the front wall 80 and rear wall 81, and are curved to provide the generally circular cross-sectional shape of the extendable section 72.

The base section 70 and extendable section 72 may also include bottom walls 86 and 88, respectively. The bottom walls 86 and 88 can, if necessary, be provided with apertures 86′ and 88′, respectively, to allow a tool or other access to the motor of the motor assembly 42. As shown in FIGS. 5-9, the bottom wall 88 may include a foot portion 89 extending generally radially outwardly from the base section 70. The foot portion 90 rigidifies bottom wall 88 and increases the area of the motor housing 48 that may engage the sectional door D.

A collar 90 can be integrally formed with the front wall 74 of the base section 70. The collar 90 is provided to facilitate attachment of camming members 66 in various positions relative to the base section 70. As such, the collar 90 includes various apertures 91 allowing the camming members 66 to be pinned to the base section 70.

To accommodate the collar 90, and prevent interference with the relative movement of the extendable section 72 to the base section 70, the front wall 80 of the extendable section 72 includes an opening 92. The opening 92 is sized according to the width of the collar 90, and travel of the extendable section 72 along the base section 70.

To facilitate guided relative movement of the extendable section 72 relative to the base section 70, the base section 70 includes channels 94, and the extendable section includes rails 96. The channels 94 are formed along the sidewalls 76 and 77 of the base section 70, and the rails 96 are formed along the sidewalls 82 and 83 of the extendable section 72. Travel of the extendable section 72 along the base section 70 is afforded by slidable movement of the rails 96 within the channels 94.

The extendable section 72 can be maintained in position, and selectively axially repositioned relative to the base section 70 using a latching mechanism, generally indicated by the numeral 100. The latching mechanism 100 includes a row of catches, generally indicated by the numeral 102, formed along the base section 70. The row of catches 102 is composed of various individual catches 103 which can be grooves formed in the rear wall 75 and sidewalls 76 and 77. The individual catches 103 are spaced apart by wall segments 104 to define various axial positions for locating the extendable section 72 relative to the base section 70. The individual catches 103 include wall sections 106 and 107. The wall sections 107 are angularly oriented with respect to the wall sections 106 to give the individual catches a tooth-shaped profile.

The latching mechanism 100 also includes tongue 108 formed on the extendable section 72. The tongue 108 is formed within a U-shaped aperture 109, and can be hingedly attached to the rear wall 81 and sidewalls 82 and 83. The tongue 108 includes a projection 110 extending into the interior of the extendable section 72. The projection 110 can be tooth-shaped to complement the tooth-shape of the individual catches 103. Upon insertion of the base section 70 into the extendable section 72, the projection 110 can be received in one of the individual catches 103 to axially position the extendable section 72 relative to the base section 70. Once the projection 110 is introduced into one of the individual catches 103, the projection 110 interacts with the individual catch 103 to prevent axial movement of the extendable section 72 with respect to the base section 70. As such, the interaction of the projection 110 and individual catches 103 provides a positive lock against movement of said extendable section 72 relative to said base section 70.

To selectively axially retract the extendable section 72 relative to the base section 70, an apertured nub 112 is formed opposite the projection 110 on the tongue 108. The apertured nub 112 is provided to receive a tool such as a screwdriver. The tool can be received within the apertured nub 112 to pry against the tongue 108. As such, the tongue 108 can be bent radially outwardly so that the projection 112 can be released from one of the individual catches 103. While thus released, the extendable section 72 can be selectively axially retracted relative to the base section 70, and the projection 110 introduced into another of the individual catches 103. As such, the overall length of the motor housing 48 can be adjusted. The motor housing 48 can be extended or retracted to account for the mounting position of the operator system 10 in order to facilitate selective blocking positioning relative to an upper portion of the sectional door D.

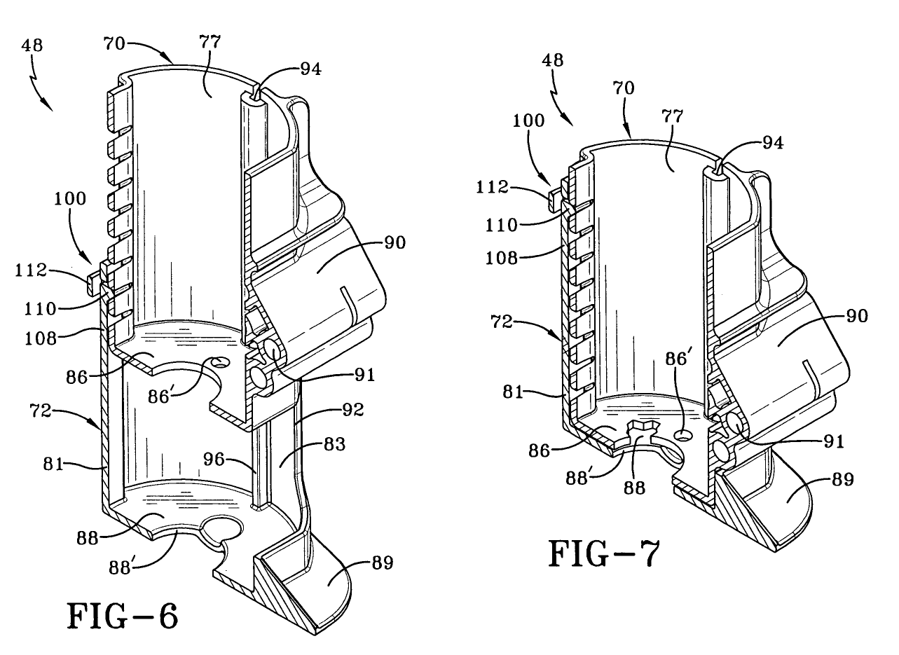

The operator system 10 is normally delivered from the factory with motor housing 48 having the extendable section 72 in the retracted position depicted in FIGS. 7 and 9. Once installed, the extendable section 72 may be manually moved to establish an effective housing length to locate bottom wall 88 in the desired blocking position for any door D and counterbalance system 20 geometry due to the design of the latching mechanism 100. The latching mechanism 100 due to the design of the catches 103 and the tongue 108 maintains extensible section 72 in any selected position and is locked to preclude retraction that might be occasioned by efforts to move the door D upwardly from the closed position. Any subsequent need to retract extensible section 72 requires that a tool be employed in the apertured nub 112 to release the projection 112 of tongue 108 from engagement with catches 103 while retraction is effected to a new selected position.

Thus, it should be evident that the adjustable motor housing for a barrier locking operator disclosed herein carries out one or more of the objects of the present invention set forth above and otherwise constitutes an advantageous contribution to the art. As will be apparent to persons skilled in the art, modifications can be made to the preferred embodiment disclosed herein without departing from the spirit of the invention, the scope of the invention herein being limited solely by the scope of the attached claims.

1. A door system comprising, a sectional door moveable between an open position and a closed position, a track system guiding movement of said sectional door, and an operator system driving movement of said sectional door, said operator system including a motor assembly having an adjustable housing and capable of pivotal movement to a door locking position, said adjustable housing having a base section, an extendable section, and a latching mechanism for maintaining said extendable section in a desired position and for permitting selective axially repositioning of said extendable section relative to said base section.

2. A door system according to claim 1, wherein said latching mechanism includes catches formed on one of said base section and said extendable section, and a tongue formed on the other of said base section and said extendable section.

3. A door system according to claim 2, wherein said catches are configured to receive said tongue to provide a positive lock against movement of said extendable section relative to said base section.

4. A door system according to claim 2, wherein said catches are defined by a plurality of grooves that are axially spaced apart to define various positions for locating said extendable section relative to said base section.

5. A door system according to claim 4, wherein said grooves have tooth-shaped profiles to receive a tooth-shaped projection formed on said tongue.

6. A door system according to claim 3, wherein said tongue includes a tooth-shaped projection formed thereon, said tooth-shaped projection being received in said catches.

7. A door system according to claim 6, wherein said tongue is hingedly attached to said extendable section so that said tongue can be bent backwards so that said tooth-shaped projection can be removed from said catches.

8. A door system according to claim 7, wherein said tongue includes an apertured nub configured to receive a tool enabling said tongue to be bent backwards.

9. A door system according to claim 1, wherein said base section and said extendable section have generally circular cross-sectional shapes, said base section being sized slightly smaller than said extendable section to telescopically fit therein, said base section provided with channels configured to receive rails provided on said extendable section, the interaction of said channels and said rails facilitating slidable movement of said extendable section relative to said base section.

10. An operator for locking a sectional door in a closed position comprising, a housing adapted to move into and out of a position for blocking movement of the door from the closed position, a base section of said housing, an extendable section of said housing interfitting with said base section, and a latching mechanism associated with said base section and said extendable section for maintaining said extendable section in any selected one of a plurality of positions relative to said base section.

11. An operator according to claim 10, wherein said housing encloses a motor for selectively moving said housing into and out of said position for blocking movement of the door.

12. An operator according to claim 10, wherein said base section and said extendable section telescopically slidingly interfit to establish an effective length of said housing to locate said extendable section at a desired position relative to said base section and the door.

13. An operator according to claim 12, wherein said base section and said extendable section have substantially similar cross-sectional configurations of differing sizes.

14. An operator according to claim 12, wherein said base section and said extendable section have generally circular cross-sectional shapes with one of said base section and said extendable section having at least one axial rail and the other of said base section and said extendable section having at least one axial channel, said channel and said rail interfitting to provide guided relative movement of said extendable section and said base section.

15. An operator according to claim 10, wherein said latching mechanism has catches on one of said base section and said extendable section and a tongue on the other of said base section and said extendable section for selectively engaging said catches such that said extendable section is manually movable in one direction and locked to preclude movement in the other direction when engaged by the door.

16. An operator according to claim 15, wherein said latching mechanism includes a release for disengaging said tongue from said catches to permit free movement of said extendable section in either of said one direction and said other direction.

17. An operator for locking a sectional door in a closed position comprising, a housing adapted to move into and out of a position for blocking movement of the door, a first section of said housing, a second section of said housing interfitting with and movable relative to said first section, and latching means to selectively maintain said second section in one of a plurality of positions relative to said first section, to permit manual movement of said second section relative to said first section in one direction and to permit manual movement of said second section relative to said first section in said one direction and in another direction.

18. An operator according to claim 17, wherein cooperating catches and a tongue maintain said second section in said one of a plurality of positions relative to said first section.

19. An operator according to claim 17, wherein said catches have tooth shaped portions and said tongue has a complementary tooth shaped portion to permit manual movement of said second section relative to said first section in said one direction and locked to preclude relative movement in said another direction.

20. An operator according to claim 17, wherein a release permits manual movement of said second section relative to said first section in said first direction and said another direction.
